(19) United States
(12) Patent Application Publication
(10) Pub. No.: US 2015/0215674 A1
(43) Pub. Date: Jul. 30, 2015

(54) INTERACTIVE STREAMING VIDEO

(71) Applicant: HEWLETT-PARKARD DEV. COMPANY, L.P., Houston, TX (US)

(72) Inventors: Michael A. Provencher, Cypress, TX (US); Jeffrey A. Blankenship, Houston, TX (US); William James Blankenship, Spring, TX (US); Kent E. Biggs, Tomball, TX (US); Ki Provencher, Cypress, TX (US)

(21) Appl. No.: 14/367,574

(22) PCT Filed: Dec. 21, 2011
(86) PCT No.: PCT/US2011/066402

§ 371 Date: Mar. 6, 2015

(51) Int. Cl. H04N 21/4722; H04N 21/81; H04N 21/44; H04N 21/4728; H04N 21/478

(52) U.S. Cl. CPC H04N 21/4722; H04N 21/4728; H04N 21/47815; H04N 21/44008; H04N 21/8133

(57) ABSTRACT

Embodiments disclosed herein relate to interactive streaming video. In one embodiment, a processor may determine the characteristics of a user interaction with a scene of a streaming video. A response to the user interaction may be determined based on information in a storage. The determined response may be performed by a processor.

### BACKGROUND

Streaming video is a popular method of receiving media content. For example, a television program may be streamed from a cable company to a television set via radio signals. Websites may allow a user to view content streamed from a server. Streaming content may allow for a separate entity to maintain control of the content and may use less storage space on a user's display device.

### BRIEF DESCRIPTION OF THE DRAWINGS

The drawings describe example embodiments. The following detailed description references the drawings, wherein:

FIG. 1 is a block diagram illustrating one example of a computing system.

FIG. 2 is a flow chart illustrating one example of a method to respond to a user interaction with an item in a streaming video scene.

FIGS. 3A and 3B are diagrams illustrating one example of identifying a selectable item in a streaming video and associating it with a response.

FIGS. 4A and 4B are diagrams illustrating one example of a user interacting with a streaming video scene and an automated response to the user interaction.

### DETAILED DESCRIPTION

In one embodiment, a user may interact with an item displayed in a streaming video scene, for example, to request information about the item or to purchase the item. A sensor may detect a user interaction, with an item or situation shown in the streaming video scene. For example, an actor may use a product in a scene of the streaming video, and a user may touch the product in the scene to receive more information about it. Interactive streaming video may allow a user to receive information associated with a video program in a comfortable setting, such as without looking up the information on an additional device. It may provide quick and easy access to information and services for a user and may provide an additional advertising venue. Interactive streaming video may be used to provide user interaction with a variety of media types, such as television programs, streaming video services, or webcasts. Interactive streaming video may allow a content provider to maintain control over the video and may use less storage space on a user's display device.

Interactive streaming video may provide flexibility by allowing different types of system configurations. For example, information about selectable items in the streaming video scene may be transmitted along with the streaming video signal. In some cases, information about selectable items within a video stream scene may be transmitted separately with the video stream, for example, through a television side band signal. The selectable item information may be stored in a database such that the information is not transmitted to the display device. For example, the database may include information about a position and time in the video stream associated with a particular selectable item and a response, and user interaction information may be compared to the database to determine the associated response. Information from a sensor sensing a user's interaction with the video scene may be processed locally at the user's display device or may be transmitted to another entity, in some cases to the entity transmitting the streaming video.

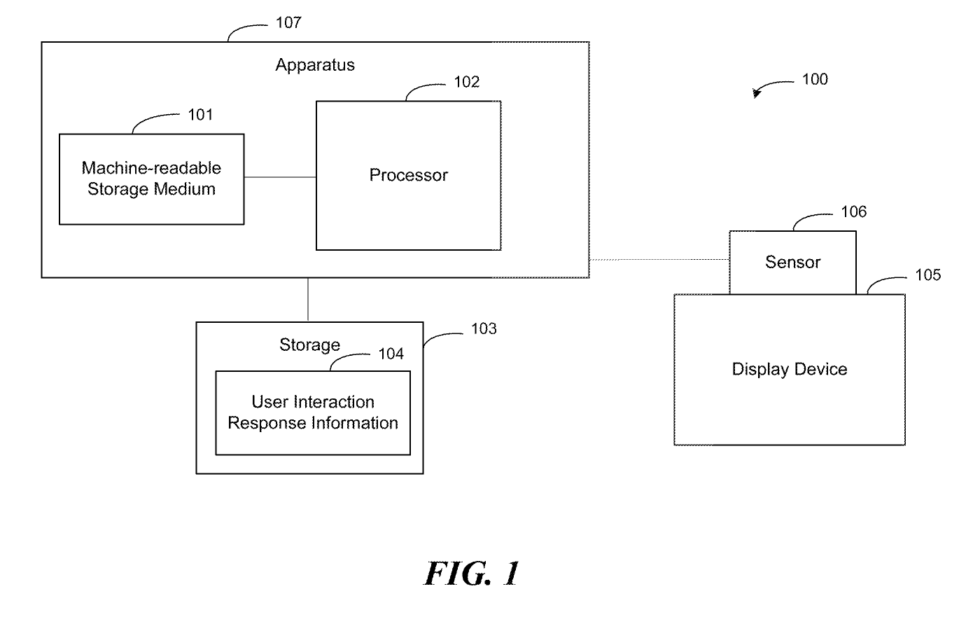

FIG. 1 is a block diagram illustrating one example of a computing system 100. The computing system 100 may be used to respond to a user interaction to an item, such as an actor, product, or location, displayed in a streaming video scene. A user's interaction may be analyzed based on information from a sensor, and a response to the interaction may be determined based on a database associating user interactions to particular items within the streaming video with responses. The computing system may then perform the determined response to the user interaction. As an example, a user may touch a product shown in a streaming video to purchase the product, which may simplify a purchasing process.

The computing system 100 may include an apparatus 107, a storage 103, a sensor 106, and a display device 105. The display device 105 may be any suitable display device for displaying streaming video. For example, the display device 105 may be a client device, such as a monitor or display on a mobile computing device, displaying video streamed from a server or may be a television with video transmitted from a cable company.

The sensor 106 may be a sensor for collecting information about a user interaction relative to a video stream scene displayed on the display device 105. For example, the sensor 106 may be a camera, infrared, acoustic, or motion sensor. The sensor 106 may send the collected information to the apparatus 107, such as via a network or wired connection, for interpretation. In some implementations, the sensor 106 may include a processor for analyzing the collected data, and information about the analysis may be sent to the apparatus 107. In one implementation, the apparatus 107 is remote from the display device 105. For example, the display device 105 or the sensor 106 may transmit information about the user interaction to the apparatus 107 via a network such that the processing is not done at the user's location.

The apparatus 107 may be any suitable apparatus for interpreting and responding to a user interaction with an item displayed within a video stream scene. The apparatus 107 may include a processor 102 and a machine-readable storage medium 101. The processor 102 may be any suitable processor, such as a central processing unit (CPU), a semiconductor-based microprocessor, or any other device suitable for retrieval and execution of instructions. In one embodiment, the apparatus 107 includes logic instead of or in addition to the processor 102. As an alternative or in addition to fetching, decoding, and executing instructions, the processor 102 may include one or more integrated circuits (ICs) or other electronic circuits that comprise a plurality of electronic components for performing the functionality described below. In one implementation, the apparatus 107 includes multiple processors. For example, one processor may perform some functionality and another processor may perform other functionality.

The machine-readable storage medium 101 may be any suitable machine readable medium, such as an electronic, magnetic, optical, or other physical storage device that stores executable instructions or other data (e.g., a hard disk drive, random access memory, flash memory, etc.). The machine-readable storage medium 101 may be, for example, a computer readable non-transitory medium. The machine-readable storage medium 101 may include instructions executable by the processor 102.

The storage 103 may be any suitable storage accessible by the processor 102. In some cases, the storage 103 may be the same as the machine-readable storage medium 101. The storage 103 may be included within the apparatus 107 or may be accessible to the processor 102 via a network. The storage may include user interaction information 104. The apparatus 107 may associate user interaction information with responses and store them in the storage 103. For example, a gesture to a particular item in the streaming video scene may be associated with a response to email a user more information about the item.

The processor 102 may receive information from the sensor 105 and determine the characteristics of a user interaction relative to a video stream scene displayed on the display device 105. The processor 102 may compare the user interaction to information in the storage 103 to determine a response to the user interaction. For example, touching a product displayed within a scene of the streaming video may result in a banner being displayed asking if the user would like to purchase the product. The processor may perform the determined response. In some cases, performing the associated response may include transmitting information about the selection to another entity that may then perform an action.

Interactive streaming video may allow an entity to provide interactive media without controlling the content and decreasing the amount of storage used on a user device. In addition, interactive streaming content provides flexibility in how an entity analyzes and responds to the user interactions. For example, in one implementation, an entity providing the interactive service may be separate from the video streaming entity. A separate processor may analyze the user interactions and compare it to a storage with associated responses without involvement of the video streaming entity. In one implementation, the video streaming entity receives information to analyze the user interaction and/or determine the associated response. In one implementation, the video streaming entity may send information about the selectable items and/or associated responses to a user's display device with the video signal or as additional information.

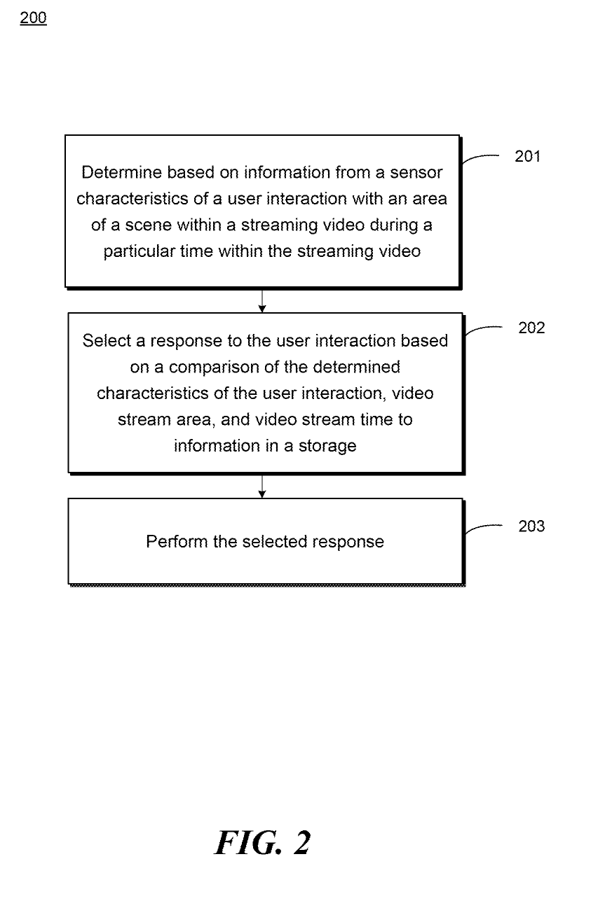

FIG. 2 is a flow chart 200 illustrating one example of a method to respond to a user interaction with an item in a streaming video scene. For example, items in a streaming video scene may be selected through user interaction, such as through eye contact, facial expression, touch, motion, voice, or remote control. A processor may receive information from a sensor about a user's interaction with respect to a streaming video scene, and the processor may determine a response to the interaction by looking up information about the interaction in a storage. Interactive streaming video may allow a user to interact with video media in an intuitive manner. For example, a user may request services, respond to an advertisement, or receive additional information while simultaneously viewing the streaming video. The method may be implemented, for example, by the processor 102 from FIG. 1.

Beginning at 201, a processor determines based on information from a sensor characteristics of a user interaction with an area of a scene within a streaming video during a particular time within the streaming video. The sensor may be any sensor for collecting information about a user interaction. For example, the sensor may detect eye contact, touch, gesture, sound, or motion relative to the streaming video scene. The sensor may be, for example, an optical, infrared, or acoustic sensor. The sensor may include a processor or other hardware for transmitting information about the sensed interaction. The sensor may be connected to a processor for interpreting the sensed interaction, may transmit information about the interaction to a processor network with the streaming video, and/or may transmit it via a network to another site, such as to a processor associated with a cable company or other entity.

The area of the scene at the particular time may correspond to an item in the scene. The scene of the streaming video may be part of a program, such as a sitcom or animation, and a user may interact with an item in the scene to select it. For example, a user may gaze for more than a particular amount of time at an image of an actor, tree, product, or store front displayed in a scene to select it. The processor may use information collected from the sensor to determine characteristics of the user interaction. For example, the processor may determine where a user touched a display device and the video streaming scene shown at that time.

The streaming video scene may include an indication of which items are selectable, such as by making them a different color or making them appear outlined. In some cases, no indication shows the user that the item is selectable. In one implementation, information about the selectable items may be transmitted separately from the video stream, such as in the television side band signal or in another manner, such as via the internet, to a processor associated with the television. In one implementation, the selectable item information is stored in a separate database such that a processor associated with the display device displaying the streaming video is not involved in determining whether a user selected a selectable item, and the display device and/or the sensor transmits the user interaction information to another device for processing the information.

Continuing to 202, a processor selects a response to the user interaction based on a comparison of the determined characteristics of the user interaction, video stream area, and video stream time to information in a storage. The same processor analyzing the sensor data may compare the user interaction information to the storage, or the processor may send the user interaction information to another processor for the comparison. For example, the interaction data may be sent to another entity to determine the meaning of the user action.

The processor may use information from the sensor to determine the meaning of the user interaction, such as to determine whether an item within the streaming video scene is selected. The processor may determine whether the object selected is a selectable object. In some cases, the processor may make a determination as to whether a user interaction is associated with a selectable item based on information in the storage. For example, the storage may include display areas and corresponding video stream times that are associated with a selectable item.

The storage may be a database or other storage type for associating a user interaction with a response. For example, if object A is selected in a streaming video scene, the storage may store a corresponding response, such as to display information about object A and to display information about object B if object B is selected. The storage may be available to a display device via a network. In some implementations, a processor not associated with the display device determines interactions with the display device based on information received from the sensor. In some implementations, the response information is stored where it may be access by the display device.

To populate the storage, an item may be identified within a scene of the video stream and associated with a response to a particular user interaction with the item. A processor, such as a processor for streaming video to a display device or a separate processor, may provide a user interface to allow a user to more easily provide automated information and services through streaming video. For example, the user interface may allow a user to view the video scene and mark items to be selectable. The user may also indicate a response for a selection of the object. The information about the selection and the response may be stored. For example, an actor may hold a soft drink in a scene, and a user may highlight the soft drink and indicate that a selection of the soft drink should cause a coupon code for the soft drink to be shown at the bottom of the television screen.

In one implementation, a processor automatically identifies objects in a scene. The processor may display the scene with the available selectable objects and allow a user to select which should be selectable or to determine a response to selecting the objects. The item may be, for example, an actor, place, or product shown in the streaming video. In some cases, selecting an item may indicate a request for more information on an activity being performed by the item, such as where an actor is playing a sport.

The response may be any suitable response. For example, the response may involve altering the video stream such that additional information is displayed, transmitting information to the user outside of the video stream, such as by email, or contacting another entity that may then respond to the user. For example, a company affiliated with a product may be contacted, and the company may then mail or email coupons for the product to the user. In some cases, the particular response may be dependent on the type of user interaction indicating selection of the item. For example, eye contact with an item for over a particular amount of time may produce a different response than touching the item. In some cases, the response includes altering the video stream such that the selected item appears to have been selected. For example, it may change color. In some cases, the response may include multiple steps, such as to display a menu asking the user whether he would like to purchase the selected item.

Moving to 203, a processor performs the selected response. The processor may transmit information about the user interaction to another entity. For example, the processor may transmit information to the user, such as an email or automated telephone message. The processor may alter the video stream, for example to change the scene in response to the selection, to display additional information in a pop up or banner to indicate the item was selected, or to make an additional item selectable. The response may be to purchase the selected item. For example, a user may have credit card information on file, and the processor may initiate a purchase process with the credit card. The processor may transmit information indicating that the user selected a product to a processor of a company associated with the product, and the company may, for example, contact the user. In some implementations, the processor may store information about the selection in a storage accessible to another processor, such as a processor associated with another entity.

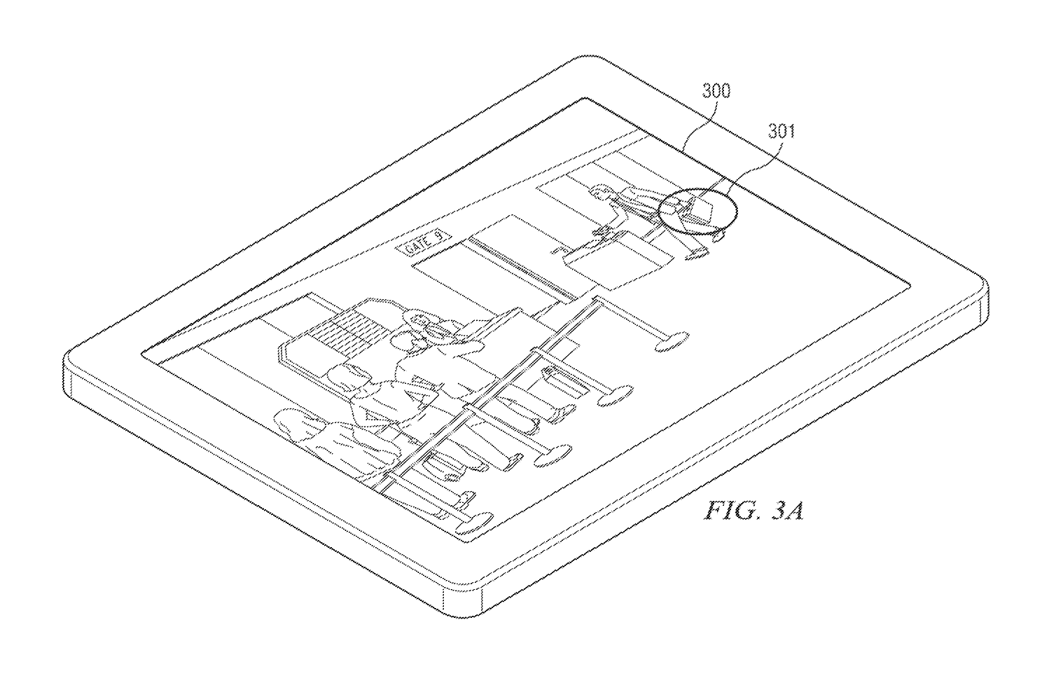

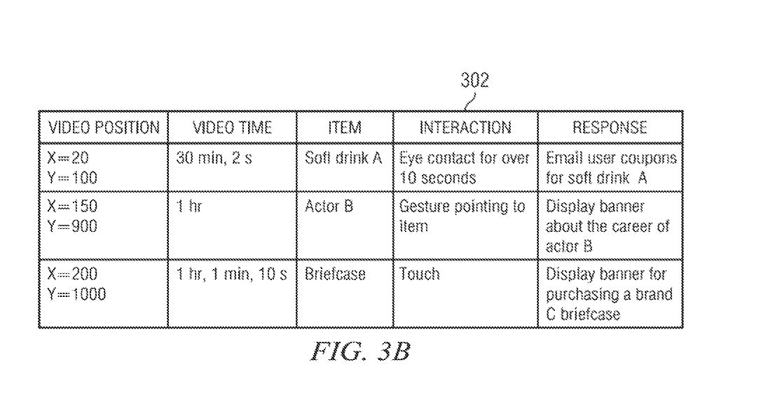

FIGS. 3A and 3B are diagrams illustrating one example of identifying a selectable item in a streaming video and associating it with a response. FIG. 3A shows a scene 300 of a streaming video. The scene 300 is a scene of passengers in an airport about to board a plane. The circle 301 identifies the briefcase in a passenger's hand. The circle 301 indicates a selectable item within the scene 300.

FIG. 3B shows a table 302 of items in the video stream and responses. For example, a touch to the briefcase which is pictured at x coordinates 200 and y coordinates 1000 at 1 hour, 1 minute, and 10 seconds into the video should have a response of a banner being displayed on the bottom of the video stream to allow a user to purchase a similar briefcase.

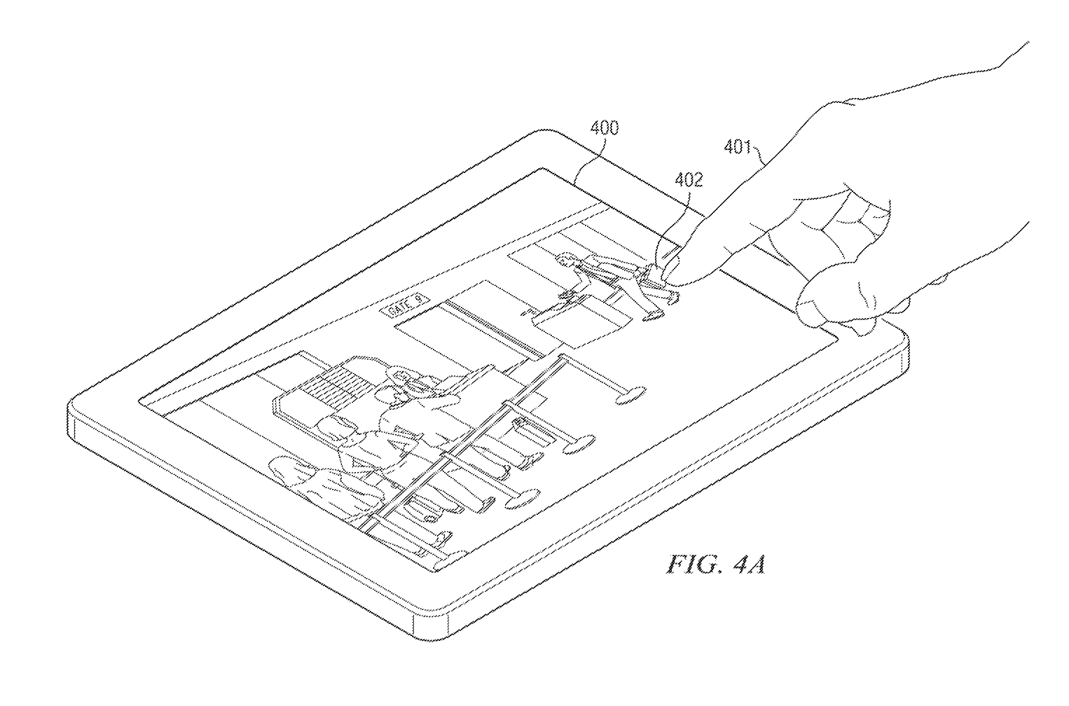

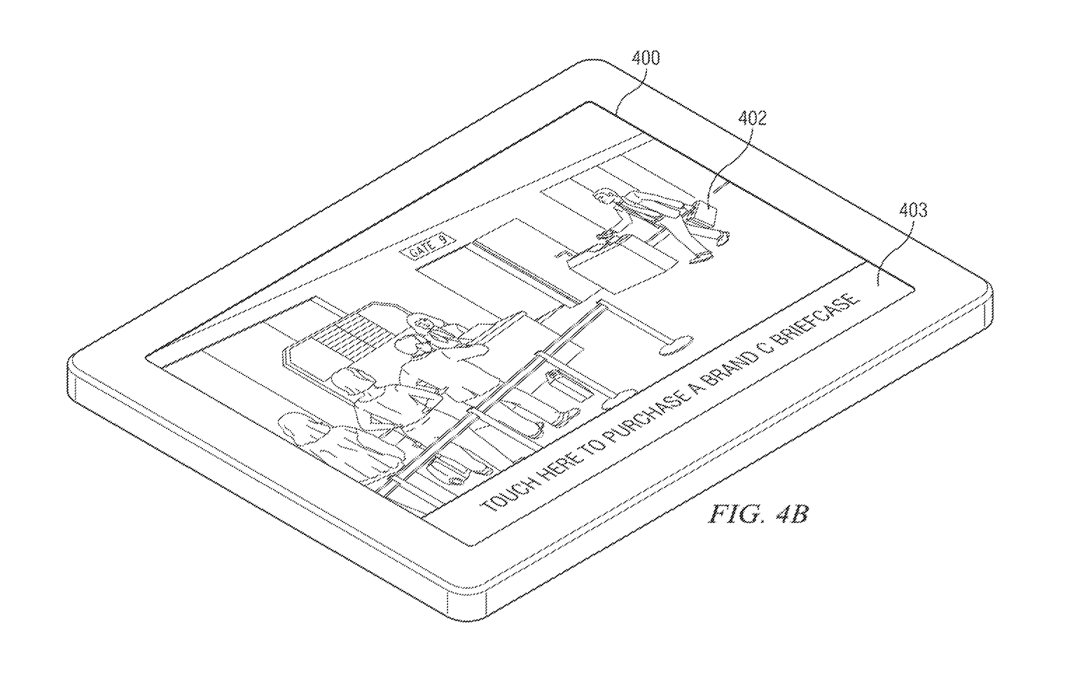

FIGS. 4A and 4B are diagrams illustrating one example of a user interacting with a streaming video and an automated response. In FIG. 3A, the streaming video scene 400 shows a video stream scene of an airport. The user hand 401 touches the briefcase 402 shown in the video stream airport scene. In FIG. 4B, the streaming video scene 400 is shown with the briefcase 402 selected and with a banner 403 providing the user an opportunity to purchase a briefcase like the shown briefcase 402. For example, a processor may determine that the response to the selection is to alter the video stream to display the banner. The processor may make the determination, for example, by looking up information about the interaction in the table 302 of FIG. 3B.

1. A machine-readable storage medium including instructions executable by a processor to:
determine based on information from a sensor characteristics of a user interaction with an area of a scene within a streaming video during a particular time within the streaming video;
select a response to the user interaction based on a comparison of the determined characteristics of the user interaction, video stream area, and video stream time to information in a storage; and
perform the selected response.

2. The machine-readable storage medium of claim 1, wherein the selected response comprises at least one of: transmitting information about the user interaction to another entity, transmitting information to the user, altering the video stream, or purchasing an item.

3. The machine-readable storage medium of claim 1, wherein performing the selected response comprises at least one of performing the selected response or transmitting information about the selected response.

4. The machine-readable storage medium of claim 1, wherein the user interaction comprises at least one of: a facial expression, eye contact, gesture, and touch.

5. The machine-readable storage medium of claim 1, wherein the user interaction indicates at least one of an inquiry or an indication to purchase an item displayed in the area of the scene at the particular time.

6. A method, comprising:
determining, by a processor, based on information collected by a sensor properties of a user interaction with a selectable item displayed in a streaming video scene on a display device;
comparing, by a processor, the item and user interaction properties to information in a storage to determine a response to the user interaction; and
performing, by a processor, the determined response.

7. The method of claim 6, further comprising:
identifying the selectable item displayed in the scene;
associating information about a response to selecting the selectable item; and
storing the association information in the storage.

8. The method of claim 7, further comprising streaming the video to the display device.

9. the method of claim 8, further comprising altering the video stream based on a selection of the selectable item.

10. The method of claim 8, further comprising altering the video stream such that the selectable item appears selectable.

11. A computing system, comprising:
a display device for displaying a video streamed from a remote device;
a sensor to collect information related to a user interaction with the video streamed to the display device; and
a processor to:
determine based on information collected by the sensor characteristics of a user interaction with an item in a scene of the streaming video displayed on the display device;
determine a response to the user interaction based on a comparison of the determined characteristic to information in a storage; and
output the determined response.

12. The computing system of claim 11, wherein the item of the scene represents at least one of: a location, person, and product.

13. The computing system of claim 11, further comprising a second processor to:
identify the item in the scene;
associate the item with the response; and
stream the video to the display device.

14. The computing system of claim 11, wherein the sensor comprises at least one of: a camera, infrared, remote control, and acoustic sensor.

15. The computing system of claim 11, wherein outputting the selected response comprises transmitting information about the user selection via a network to an entity for responding to the selection.
